(19) United States
(12) Patent Application Publication
(10) Pub. No.: US 2012/0005112 A1
(43) Pub. Date: Jan. 5, 2012

(54) SUBMISSION VALIDATION SYSTEM AND METHOD

(76) Inventors: Bradley Woodworth, (US); Jason Whitney, Lee's Summit, MO (US); Manish Sohaney, (US)

(21) Appl. No.: 13/040,146

(22) Filed: Mar. 3, 2011

Related U.S. Application Data
(60) Provisional application No. 61/310,160, filed on Mar. 3, 2010.

(51) Int. Cl. G06Q 50/00

(52) U.S. Cl. 705/313

(57) ABSTRACT

The present general inventive concept provides a system and method to analyze and validate data submission of real estate data related to property value, store the real estate data, and track any manipulation thereof, thereby providing secure real estate data with increased accuracy.

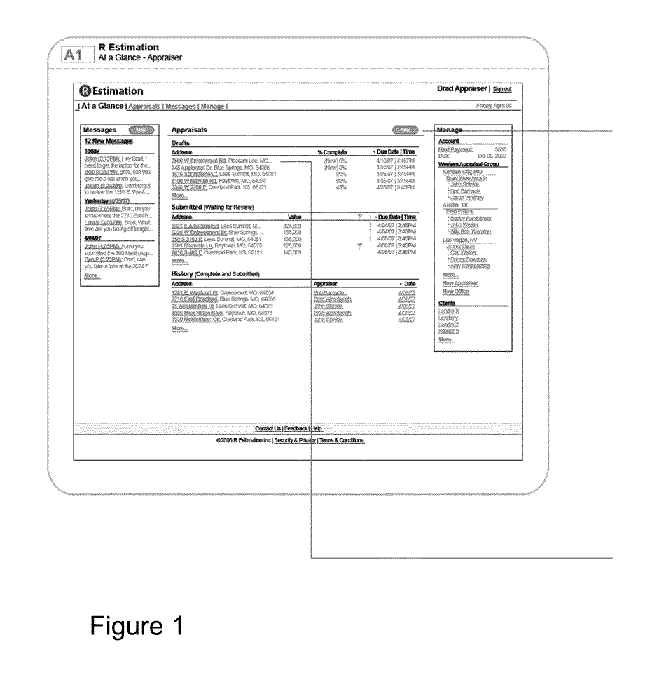

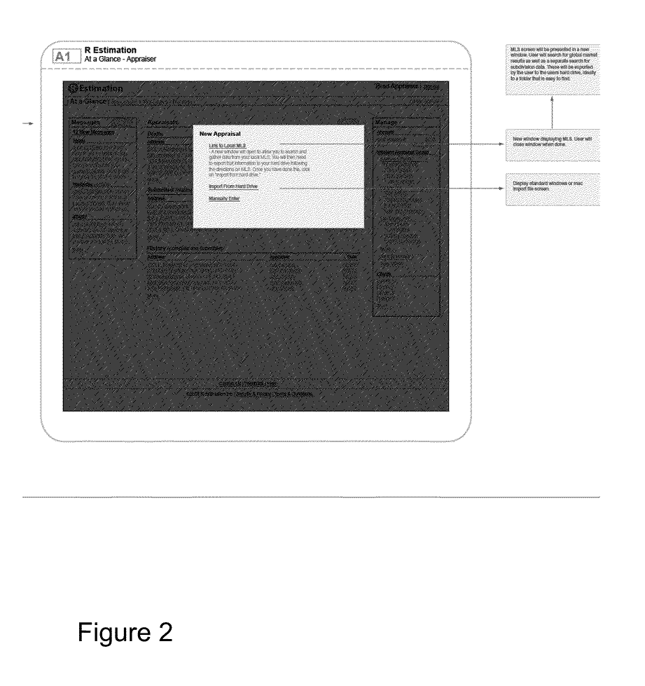

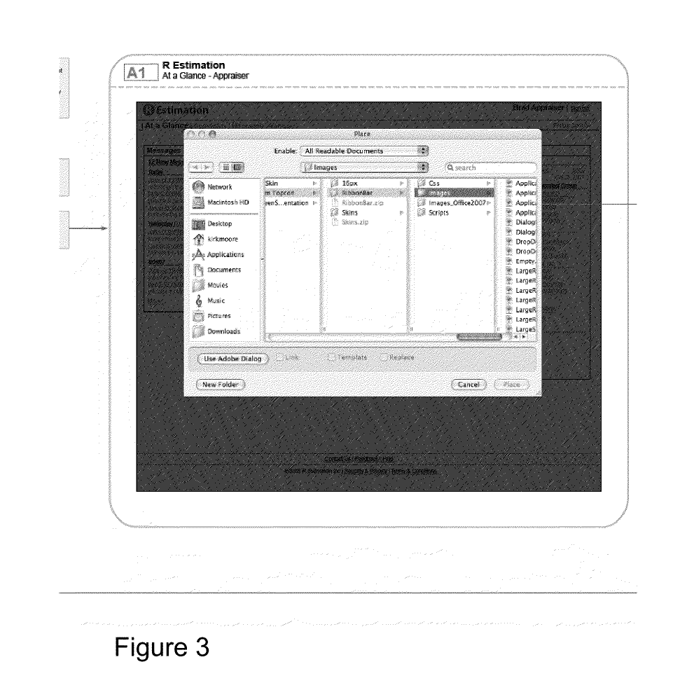

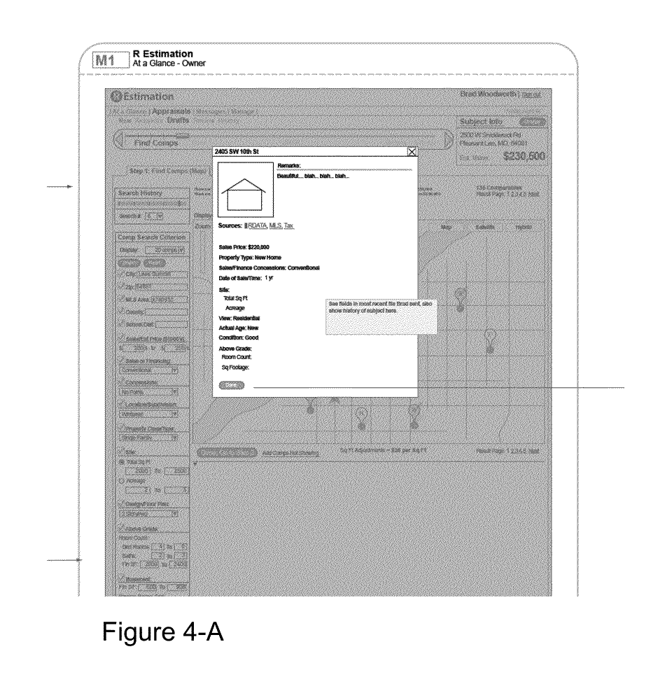

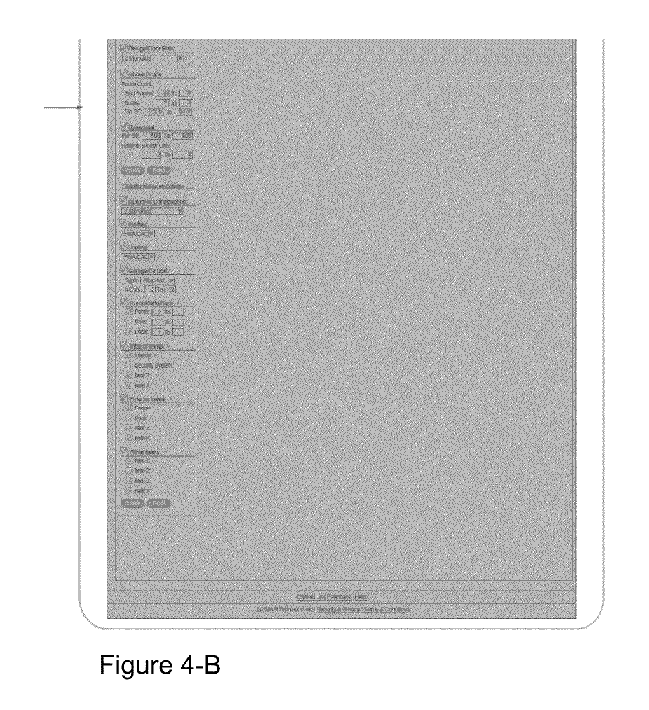

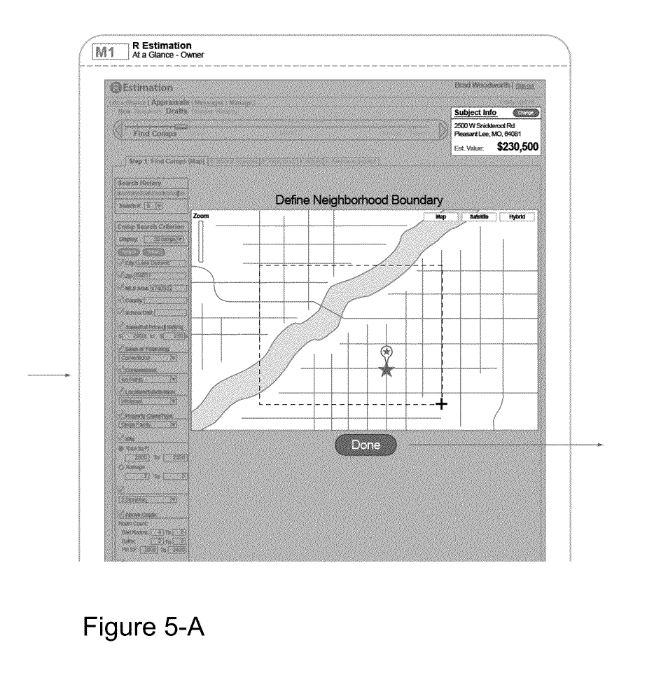

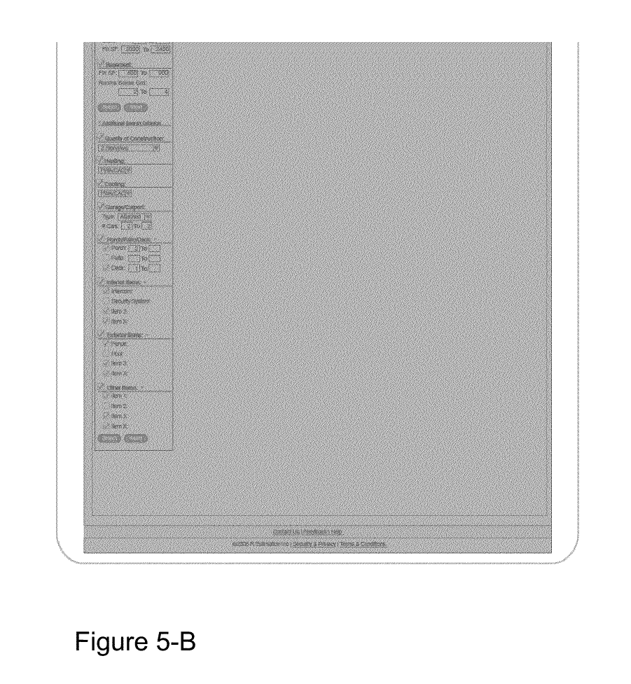

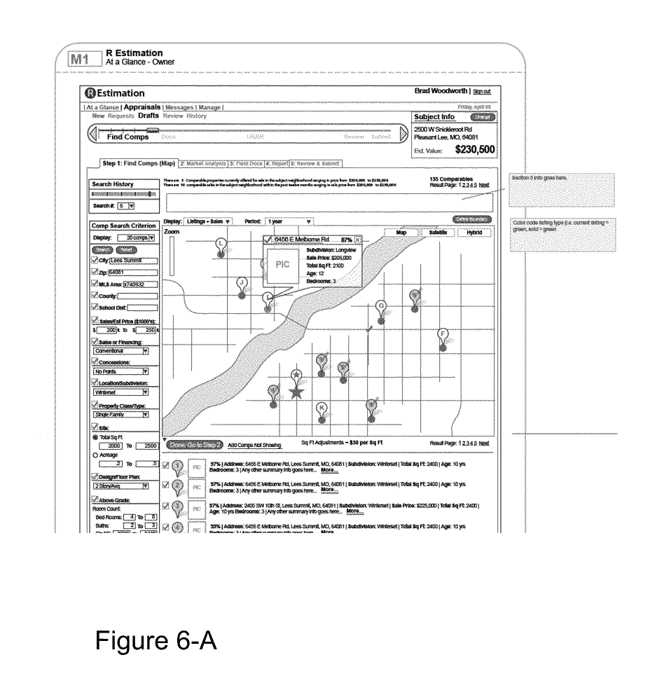

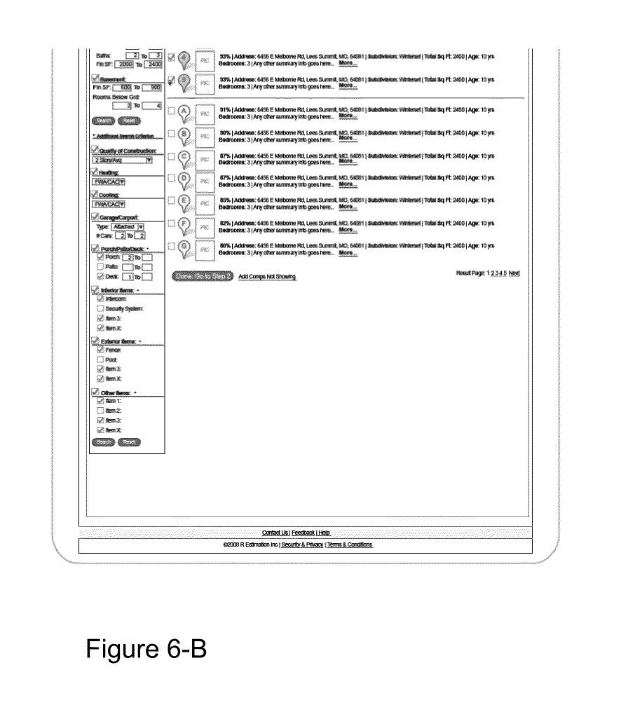

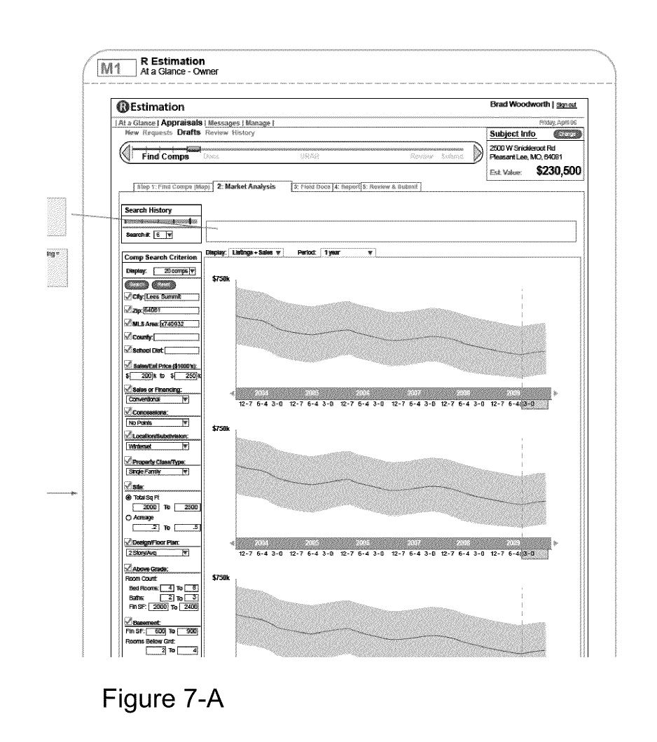

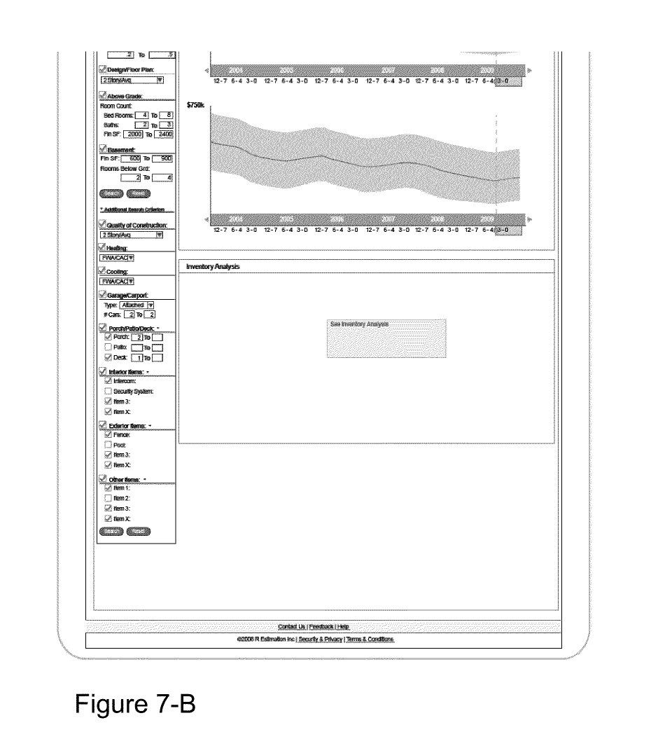

### CROSS-REFERENCE TO RELATED APPLICATION

This application claims the priority of earlier filed U.S. Provisional Application Ser. No. 61/310,160, filed Mar. 3, 2010, the disclosure of which is hereby incorporated herein by reference in its entirety to the extent permitted by law.

### BACKGROUND OF THE INVENTION

1. Field of the Invention

The present general inventive concept relates to a system and method to validate data submitted to provide transparency to users, and more particularly to a system and method to analyze and validate data submission of real estate data related to property value, store the real estate data, and track any manipulation thereof, thereby providing secure real estate data with increased accuracy.

2. Description of the Related Art

The United States residential mortgage market is in financial chaos because loan defaults are at historic highs. The massive defaults are attributed to issuance of loans for properties that exceed the true market value of the property.

Financial institutions or “Lenders” are actively engaged to understand the risk in existing loan portfolios as well as identify methods to lower future risk on new loans. Some conventional methods include analyzing credit risk, which is an important factor to evaluate loan defaults due to low credit, and analyzing appraisal values, which is an important factor to evaluate risk of loss due to inflated property values.

Conventional software programs process appraisal paperwork required by a financial institution customers as part of the home loan evaluation process. This software, which provides the appraisal paperwork in an electronic version, is quicker than completing the same paperwork by hand. Regardless, the form completion phase involves significant manual data entry.

Accordingly, there is a demand for a more efficient way to generate real estate appraisals that are superior to traditional programs that reduce the time spent in the form completion phase to allow the processing of more appraisals with the same staff or the same number of appraisals with fewer staff to generate a lower cost per appraisal. An additional advantage includes quicker appraisal turnaround times.

### SUMMARY OF THE INVENTION

The present invention comprises a method of auditing a market analysis submission to determine the accuracy of that submission. More specifically, the method includes identifying one or more points in time using historical data contained in a database and displaying each of those points in time for selection by the user or permitting a user to enter a point in time. The method then comprises delivering and displaying historical data from the database relating to the selected or entered point(s) for purposes of auditing accuracy.

In still another embodiment of the invention, the user enters current sales data and compares that current sales data with historical data in the database. The method further comprises indicating to the user whether that current sales data or historical data is valid or invalid.

Various embodiments of the present general inventive concept can be embodied as computer readable codes on a computer readable recording medium. The computer readable recording medium may include any data storage device suitable to store data that can be thereafter read by a computer system. Examples of the computer readable recording medium include, but are not limited to, read-only memory (ROM), a random-access memory (RAM), CD-ROMs, magnetic tapes, floppy disks, optical data storage devices, and carrier waves (such as data transmission through the internet). The computer readable recording medium can also be distributed over network coupled computer systems so that the computer readable code is stored and executed in a distributed fashion. Various embodiments of the present general inventive concept may also be embodied in hardware or in a combination of hardware and software

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

The figures illustrate screenshots of the present general inventive concept in use.

### DETAILED DESCRIPTION OF THE INVENTION

The present general inventive concept (hereinafter referred to as the “rMarket tool” or “rMarket”) provides a unique solution to address the aforementioned deficiencies in the prior art.

Unique Solution: rEstimation creates two components to every valuation: Market analysis+Valuation Report. Report will be sent to potential client. Market analysis will be the tool to validate/review and substantiate value.

Unique Solution: rMarket pulls all/current/historic properties within the geocoded boundaries defined or selected and immediately presents the rMarket as follows:

1. Search page: Includes search criteria—Search, map—Map and Current to 12 months of data within the market boundary. This includes Section #3 analysis. rEstimation terms section #3 as follows: calculations per search will be: a. Price: High, Low , Median ; b. Age: High, Low, Median; c. Property values: Increasing, stable, decreasing. d. Demand/supply: shortage, in balance, over supply e. Marketing time: under 3 mnths, 3-6 mnths, over six mnths

2. Graph page-Graphs: Subject/comparable data is plotted against statistic measurements: Median Price, Median Age etc. This defines trends. For example, Subject property's historic property information will be posted on the graphs—subject sold in Feb. 23, 2004 for $135,000, subject was listed and never sold on Apr. 15, 2006 and final list price was $145,000, subject sold on Jul. 8, 2008 for $15,000.

Recorded data from various sources (MLS database, property records/title records) will be analyzed and presented on the graph.

Each subject data point will be evaluated against the statistical measure—median price/median age/median Price/sf. The difference between these number—subject historic data point and statistical measurement will be communicated as a % deviation.

Subject property typically will develop a relationship against defined statistical measures, that is subject is a certain % below or certain % above median over time. This relationship that will be recorded and utilized to classify subject property valuation and comparable property validation.

For example, a hypothetical Subject property clearly has historic valuations below the market's median price. This relationship has defined a trend, but the appraisal/bpo document submitted to the lender shows the subject property's opinion of value above the median price. This stated fact of opinion of value above the median price would be highlighted for further review. This type of flagging process is useful in tracking potentially fraudulent or habitually erroneous sources of data.

This relationship of historic data/transaction points to statistical measurements can also be used to verify and substantiate the use of comparable sales within an appraisal or valuation document.

Slider bar allows users to quickly scroll back/analyze history and see how subject and comparables interact with statistical measurements. User can quickly determine a trend using graphical interface. If there is 25 years of data then the scrolling of years will go back 25 years.

Unique solution: The above procedure is repeated each and every search and allows user to define the appropriate market analysis to define the market/comparables for the subject property. For example, a user completes 15 independent searches of a comparable database to find 6 qualified comparables properties to evaluate against the subject property.

Each of the 15 searches are packaged with the following analysis:

a. Resulting data from 0 to 12 months from the date of search.

b. Subject and comparable historic data points on the following graphs—Median Price, Median Age, Median Price/Sf.

c. 1004 mc analysis created for each and every search

Step #4. Develop an opinion of value with selected data:

Unique solution: comparable selected data is continually updated against rEstimation database. Changes will be presented to user. A shared database will allow all users to benefit from contributions of other professionals within the real estate community. For example,

Step #5: Change date of appraisal (New Valuation—historic/baseline market analysis)

Unique solution: rEstimation re-casts historic MLS databases so that a user is presented data as of a historic date so that both a current value (today's date) and a historic value (historic date) can be used as business metric to arrive at better risk decisions.

1. Re-characterized historical MLS data to present as if to fit in new time period. Historic MLS data has a status of either—Sold, Expired, Cancelled etc.

User wants to know what property's status was as of a historic date or user wants to know what the market looked like as of a historic date.

From the date of the original search, all historic data bases are re-characterized per a date and per a status for as far back as data is stored, possibly 10 years or more.

For example. Comparable—123 B Street was sold on Sep. 23, 2003 and again on sold on May 25, 2008. In order to properly evaluate the historic sold prices, a user must be able to formalize the market, such as by creation of the 1004mc analysis and graphical representations including information such as how subject and comparable sold prices interact with median sales price, median age etc.

rEstimation's algorithm tracks property through time placing each and every property in pre-defined time periods. Each time period is evaluated statistically to create market analysis. As the user scrolls forward and backward through time the market is re-created for any and all historic periods.

2. User is allowed to use previously defined searches to select data in new valuation period. rEstimation allows users to define markets, comparables to develop an opinion of value today (current date). If a historic valuation is to be considered, all current searches used to develop a current valuation can be used back in time/historically. For example, user, (present time), defines the following searches:

Search #1 (current date)—location=Raintree Lake, Floor plan=1.5 story.

Results as of today: Active Listing=10 properties

Pending Listings=3 properties

Sold=2 properties.

Graphs communicate the results of this search with this present day data.

1004MC communicate the results of this search with this present day data.

Search #2—(current date): location=Winterset Park, Floor plan=1.5 stories, Garages=3.

Results as of today: Active Listings=5 properties; Pending Listings=2 properties; Sold=1 properties

Graphs communicate the results of this search with this present day data.

1004MC communicate the results of this search with this present day data.

3. All graphs and 1004mc analysis etc will be refreshed given new data within each previously defined search.

Present day opinion of value is finalized. Then user can put in a historic date such as Sep. 23, 2003. Now user can look again at the previously defined searches and select the appropriate data:

Search #1 (as of Sep. 23, 2003)—location=Raintree Lake, Floor plan=1.5 story.

Results as of today: Active Listing=6 properties; Pending Listings=10 properties; Sold=10 properties.

Graphs communicate the results of this search with this present day data.

1004MC communicate the results of this search with this present day data.

Note: Data is time specific. There are different numbers of active listings, pending listings and sold data. Also graphs and 1004mc analysis will reflect data as of Sep. 23, 2003.

Search #2 (as of Sep. 23, 2003): location=Winterset Park, Floor plan=1.5 stories, Garages=3.

Results as of today: Active Listings=10 properties; Pending Listings=5 properties; Sold=10 properties

Graphs communicate the results of this search with this present day data.

1004MC communicate the results of this search with this present day data

Note: Data is time specific. There are different numbers of active listings, pending listings and sold data. Also graphs and 1004mc analysis will reflect data as of Sep. 23, 2003.

Unique solution: rEstimation presents reports/appraisals/bpo's to clients. Lenders/reviewers will be given the following functionality:

1. Data within that report is continually updated utilizing rEstimation's database. Issues/discrepancies are highlighted and/or red flagged on a real-time basis. Each appraisal/bpo document will have a comparison analysis completed. This analysis will be directly linked to rEstimation's community database. If any material changes were entered into the database after the report was finalized and presented to the lender, then that information will be updated and presented to the lender.

2. Processor/underwriter/reviewers can quickly see the market analysis per search. Report will come with a definitive opinion of value and market analysis. Reviewer can look at the entire market analysis—each/every search with resulting data, graphs of each search and 1004mc analysis for each search. Unless a reviewer is a member of the local data provider, such as MLS member, then a reviewer is unable to understand the market and comparable the user can select.

3. Reviewers can do “What-if” Opinions of values using previously defined searches etc. Quickly understand the market. Could allow the market boundaries to be redefined and opinion of values re-developed by reviewers. Reviewers can take what has been completed and test value using the pre-defined searches and resulting data. Review can quickly complete a “What-if” Opinion of value to either substantiate or refute submitted valuations. This tool allows review of properties in a fraction of the time.

4. Both market data and opinion of values are tied together in real time. For example, subject property was appraised valued at $140,000. This value was confirmed and underwritten by the lender and further substantiated by a reviewer/auditor. Subject property has the following data tied to the property:

a. Market analysis. Market analysis comprises of graphs and 1004mc analysis per each and every search completed. Subject value ties to the market statistics such as median price. This relationship of subject value to median price is a value indicator. As long as the market isn't changing, i.e. new homes etc. within the market, then the value indicator—subject value/median price—should be consistent over time. If the market median price begins to fall then the subject value will typically follow. It is a quick, easy and cost efficient way to determine value of assets in portfolios.

b. All searches with the valuation. Each search can produce similar property results no matter the date. For example. Subject was appraised 5 years previous and certified as a good analysis. Today (five years later) lender wants an additional valuation completed. Previous searches produce new resulting comparables. These new comparables can be quickly evaluated to further substantiate and subject the above (4a) valuation analysis.

The foregoing description of the embodiments of the invention has been presented for purposes of illustration and description, and is not intended to be exhaustive or to limit the invention to the precise form disclosed. The description was selected to best explain the principles of the invention and practical application of these principles in order to enable others skilled in the art to best utilize the invention in various embodiments and with such modifications as are suited to the particular use contemplated. It is intended that the scope of the invention not be limited by the specification, but be defined by the claims as set forth below.

What is claimed is:

1. A method of auditing a market analysis submission to determine the accuracy of said submission, said method comprising the steps of:
identifying one or more points in time using historical data contained in a database and displaying each of said one or more points in time for selection by said user, or permitting a user to enter a point in time; and
delivering and displaying historical data from said database for said point in time selected or entered by said user.

2. The method according to claim 1, wherein historical data includes number of days at least one property was for sale, number of similar properties were for sale during the number of days the at least one property was for sale, selling price for each of said similar properties; tax information for said property; tax information for said similar properties; a photograph of said property; and a photograph of said properties.

3. The method according to claim 1, wherein at least one point in time is when a property was for sale.

4. The method according to claim 1, further comprising the steps of:
allowing entry of current sales data by said user; and
comparing said current sales data with historical data in said database; and
indicating to said user whether said current sales data or said historical data is valid or invalid.
